(19) United States
(12) Patent Application Publication
(10) Pub. No.: US 2024/0080179 A1
(43) Pub. Date: Mar. 7, 2024

(54) SIGNAL DETERMINATION DEVICE, MOVABLE OBJECT, SIGNAL DETERMINATION METHOD, AND COMPUTER READABLE STORAGE MEDIUM

(71) Applicant: HONDA MOTOR CO.,LTD., Tokyo (JP)

(72) Inventors: Daisuke SAITO, Tokyo (JP); Yuki HIRONO, Tokyo (JP); Yuichi OHTOMO, Tokyo (JP); Yuta NAKATA, Tokyo (JP)

(21) Appl. No.: 18/458,166

(22) Filed: Aug. 30, 2023

(30) Foreign Application Priority Data
Sep. 5, 2022 (JP) 2022-141038

(51) Int. Cl. H04L 7/04; H04L 7/06

(52) U.S. Cl. CPC H04L 7/041; H04L 7/06

(57) ABSTRACT

A signal determination device includes an identification unit which identifies a reference signal that serves as a reference to identify an abnormal signal among a plurality of signals detected in the communication network, a time interval estimation unit which estimates a time interval of signals that are to be input in series to the communication network based on detection timing of the plurality of signals detected in the communication network, a timing estimation unit which estimates timing at which a plurality of signals is to be detected in the communication network after the reference signal, and a determination unit which determines whether each of the plurality of signals detected in the communication network after the reference signal is a normal signal based on the timing estimated by the timing estimation unit and detection timing of the plurality of signals detected in the communication network after the reference signal.

The contents of the following Japanese patent application(s) are incorporated herein by reference:

NO. 2022-141038 filed in JP on Sep. 5, 2022.

### BACKGROUND

### 1. Technical Field

The present invention relates to a signal determination device, a movable object, a signal determination method, and a computer readable storage medium.

### 2. Related Art

Patent Document 1 and Patent Document 2 disclose techniques of detecting an illegal signal that is to be input to a communication network.

### LIST OF CITED REFERENCES

Patent Document 1: Japanese Patent Application Publication No. 2021-136631
Patent Document 2: Japanese Patent Application Publication No. 2021-064921

### BRIEF DESCRIPTION OF THE DRAWINGS

FIG. 1 conceptually illustrates a system configuration of a movable object 10 in an embodiment.

FIG. 2 is a block diagram schematically illustrating a functional configuration included in an ECU 110.

FIG. 3 is a diagram for describing a method of calculating a period of a signal.

FIG. 4 is a diagram for describing processing of setting a reference signal to be used to detect an illegal signal.

FIG. 5 schematically illustrates a state in which a signal 330 is delayed from periodic input timing of 10 ms due to contention with another signal.

FIG. 6 schematically illustrates a state in which a signal 430 is delayed from periodic input timing without involving contention with another signal.

FIG. 7 is a diagram for describing processing for a determination unit 240 to determine whether a signal is a normal signal or an abnormal signal.

FIG. 8 illustrates determination processing when input of a signal to communication network 180 causes contention with another signal.

FIG. 9 is a flowchart illustrating overall processing related to a signal determination method executed by the ECU 110.

FIG. 10 is a flowchart illustrating overall processing related to the determination processing whether a signal is a normal signal or an abnormal signal.

FIG. 11 illustrates an example of a computer 2000.

### DESCRIPTION OF EXEMPLARY EMBODIMENTS

Hereinafter, the present invention will be described by way of embodiments of the invention. However, the following embodiments are not intended for limiting the invention according to the claims. In addition, not all combinations of features described in the embodiment are essential to the solution of the invention.

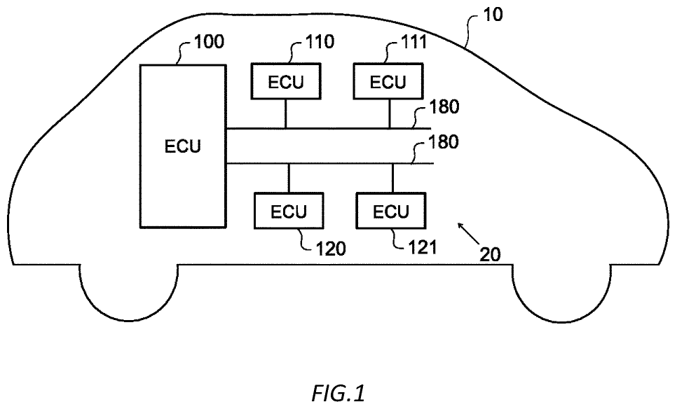

FIG. 1 conceptually illustrates a system configuration of a movable object 10 in an embodiment. In the present embodiment, the movable object 10 is a vehicle. The movable object 10 includes a system 20. The system 20 includes a plurality of electronic control units (ECUs) including ECUs 100, 110, 111, 120, and 121. The ECUs included in the movable object 10 include an ECU configured to control equipment which directly affects travelling of the movable object 10 such as, for example, an engine, a transmission, and a steering device. The ECUs included in the movable object 10 include an ECU configured to control equipment which does not directly affect the travelling of the movable object 10 such as, for example, an air conditioner and a navigation device. The ECUs 100, 110, 111, 120, and 121 are examples of in-vehicle equipment.

The ECUs included in the movable object 10 mutually communicate by controller area network (CAN) communication. Each of the ECUs included in the movable object 10 is connected so as to be mutually communicable by a plurality of communication network 180. The ECU 100 functions as a gateway which relays communication between a plurality of communication networks 180.

The communication network 180 is a communication network to which signals are expected to be input at a predetermined time interval. In the present embodiment, the communication network 180 is a communication network compliant to a CAN standard. The communication network 180 is an example of a communication network.

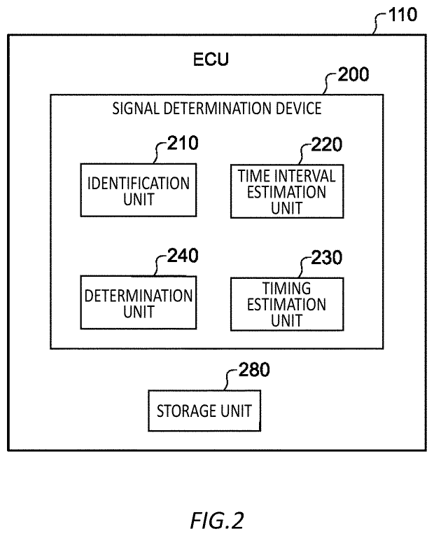

FIG. 2 is a block diagram schematically illustrating a functional configuration included in the ECU 110. The ECU 110 includes a signal determination device 200 and a storage unit 280. The ECU 110 includes a function of determining whether a signal that is input to the communication network 180 is a normal signal or an abnormal signal.

In the present embodiment, the abnormal signal may be an illegal signal which is to be input when an attack on the communication network 180 is performed by a third party. Examples of the attack on the communication network 180 can include an impersonation attack, a DoS attack, and the like. The abnormal signal may be a non-normal signal which is to be irregularly input by an ECU other than the ECU 110 to the communication network 180.

The signal determination device 200 may be implemented by a processor such as a CPU which performs computing processing. The storage unit 280 may include a nonvolatile storage medium such as a flash memory or a volatile storage medium such as a random access memory. The ECU 110 may be configured to include a computer. The ECU 110 executes various types of control when the signal determination device 200 operates according to a program stored in the nonvolatile storage medium.

The signal determination device 200 includes an identification unit 210, a time interval estimation unit 220, a timing estimation unit 230, and a determination unit 240.

The identification unit 210 identifies a reference signal that serves as a reference to identify an abnormal signal among a plurality of signals detected in the communication network 180. The time interval estimation unit 220 estimates a time interval of signals that are to be input in series to the communication network 180 based on detection timing of the plurality of signals detected in the communication network 180. For example, the time interval estimation unit 220 estimates a period of a signal that is to be input to the communication network 180.

The timing estimation unit 230 estimates timing at which a plurality of signals is to be detected in the communication network 180 after the reference signal based on detection timing of the reference signal and the time interval. The determination unit 240 determines whether each of the plurality of signals detected in the communication network 180 after the reference signal is a normal signal based on the timing estimated by the timing estimation unit 230 and detection timing of a plurality of signals detected in the communication network 180 after the reference signal.

The timing estimation unit 230 may calculate timing which is calculated by adding a value obtained by multiplying the time interval by a positive integer to the detection timing of the reference signal, as the timing at which the plurality of signals is to be detected in the communication network 180 after the reference signal.

When a difference between detection timing of a signal detected in the communication network 180 after the reference signal and the timing estimated by the timing estimation unit 230 is a predetermined value or less, the determination unit 240 may determine that the signal detected in the communication network 180 after the reference signal is a normal signal.

The time interval estimation unit 220 may estimate the time interval based on a mean value of differences of detection timing of signals detected in series in the communication network 180 within a predetermined time span.

The timing estimation unit 230 may calculate timing which is calculated by adding a value obtained by multiplying the time interval by a positive integer to the detection timing of the reference signal, as the timing at which the plurality of signals is to be detected in the communication network 180 after the reference signal. The time interval estimation unit 220 may set a length of the predetermined time span according to a positive integer by which the time interval is multiplied. The time interval estimation unit 220 may set a length of the predetermined time span such that an error of the timing estimated by the timing estimation unit 230 which is predicted from the positive integer becomes a predetermined value or less. The time interval estimation unit 220 may update the time interval before a predetermined time elapses. The identification unit 210 may update the reference signal by specifying, as a new reference signal, a signal detected after a currently set reference signal before a predetermined time elapses.

At estimated timing at which a first signal is to be detected, when a second signal that is not a signal of a determination target on whether a signal is a normal signal is detected, the timing estimation unit 230 may newly estimate timing obtained by adding a predetermined signal length to detection timing of the second signal as the timing at which the first signal is to be detected.

When a difference between detection timing of the first signal detected in the communication network 180 after the currently set reference signal and timing after a positive integer multiple of the time interval has elapsed from the detection timing of the reference signal is a predetermined value or less, the identification unit 210 may identify the first signal as a new reference signal.

A configuration may be adopted where when a time interval between a first signal and a second signal which are detected in series in the communication network 180 is a predetermined interval or less, the identification unit 210 does not identify the second signal as the reference signal, and based on a requirement that at least the time interval between the first signal and second signal detected in series in the communication network 180 exceeds the predetermined interval, the identification unit 210 identifies the second signal as the reference signal.

In the present embodiment, a signal having a predetermined specific CAN ID is set as a determination target on whether a signal is a normal signal or an abnormal signal. Therefore, unless specifically stated, in the present embodiment, a signal to which a specific CAN ID is assigned will be described. For a purpose of clear illustration of a signal to be transmitted through the communication network 180, each of the drawings in the present embodiment is not scaled on a constant time scale.

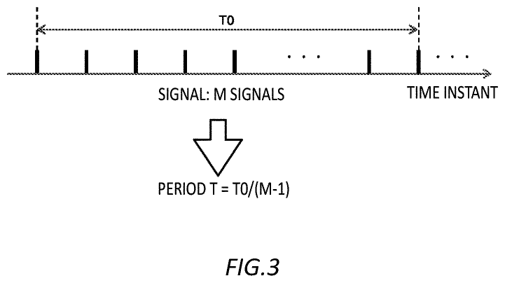

FIG. 3 is a diagram for describing a method of calculating a period of a signal. As illustrated in FIG. 3, in the communication network 180, the signal determination device 200 detects M signals within a time span T0. In this case, the time interval estimation unit 220 calculates the period of the signal by T0/(M−1). In the present embodiment, for a purpose of ease of the description, it is assumed that the period of the signal is calculated at 10 ms.

The time interval estimation unit 220 further calculates an estimation error of a period T of the signal. For example, the time interval estimation unit 220 may calculate a standard error as an estimation error of the period T of the signal.

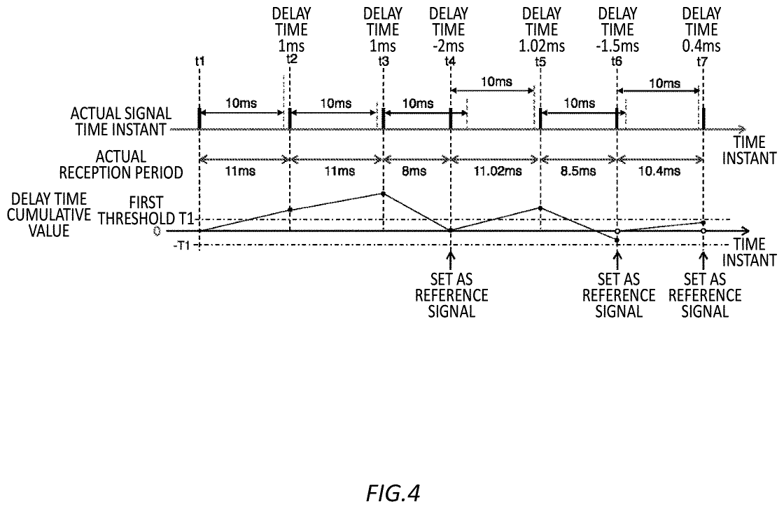

FIG. 4 is a drawing for describing processing of setting a reference signal to be used to detect an illegal signal. In FIG. 4, an actual signal time instant indicates a time instant at which a signal is actually detected in the communication network 180 by the signal determination device 200. In the present embodiment, the time instant at which the signal is detected will be described as a time instant at which reception of the signal is ended. For example, the time instant at which the signal is detected may be a time instant at which the signal determination device 200 has ended reception of all the signals. In another embodiment, the time instant at which the signal is detected may be a time instant at which reception of the signal is started.

In FIG. 4, an actual signal period is a time interval of signals detected in series in the communication network 180. Signals set as processing targets in the present embodiment are set as signals expected to be input to the communication network 180 in the period of 10 ms. The identification unit 210 identifies a signal, as the reference signal, which has a difference (delay time) between a time instant after a time of a positive integer multiple of the period of 10 ms from the detection time instant of a certain signal has elapsed and the detection time instant is a first threshold or less. The identification unit 210 calculates a delay time cumulative value by adding the delay time each time each signal is received. The identification unit 210 identifies a signal in which the delay time cumulative value is the first threshold or less as the reference signal. In the present embodiment, for clarity of the processing of setting the reference signal, the first threshold is set at 0.5 ms.

In FIG. 4, a time instant t1 is set as a time instant at which a certain signal is detected in the communication network 180. The signal determination device 200 detects a next signal at a time instant t2 when a time of 11 ms has elapsed from the time instant t1. The identification unit 210 calculates a difference between the time instant t2 and timing at which a time of the period of 10 ms has elapsed from the time instant t1 as the delay time. Accordingly, the delay time at the time instant t2 becomes 1 ms. Therefore, the identification unit 210 calculates 1 ms as the delay time cumulative value at the time instant t2. Since the delay time cumulative value exceeds the first threshold, the identification unit 210 does not identify the signal received at the time instant t2 as the reference signal.

Subsequently, the signal determination device 200 further detects a next signal at a time instant t3 when a time of further 11 ms has elapsed from the time instant t2. The identification unit 210 calculates a difference between the time instant t3 and timing at which a time of the period of 10 ms has elapsed from the time instant t2 as the delay time. The delay time at the time instant t2 becomes 1 ms. Therefore, the identification unit 210 calculates 2 ms as the delay time cumulative value at the time instant t3. Since the delay time cumulative value exceeds the first threshold, the identification unit 210 does not identify the signal received at the time instant t3 as the reference signal.

Subsequently, the signal determination device 200 further detects a next signal at a time instant t4 when a time of further 8 ms has elapsed from the time instant t3. The identification unit 210 calculates a difference between the time instant t4 and timing at which a time of the period of 10 ms has elapsed from the time instant t3 as the delay time. The delay time at the time instant t4 becomes −2 ms. Therefore, the identification unit 210 calculates 0 ms as the delay time cumulative value at the time instant t4. Since the delay time cumulative value is the first threshold or less, the identification unit 210 identifies the signal received at the time instant t4 as the reference signal, and sets the time instant t4 as a reference time instant.

Subsequently, the signal determination device 200 further detects a next signal at a time instant t5 when a time of further 11.02 ms has elapsed from the time instant t4. The identification unit 210 calculates a difference between the time instant t5 and timing at which a time of the period of 10 ms has elapsed from the time instant t4 as the delay time. The delay time at the time instant t5 becomes 1.02 ms. Therefore, the identification unit 210 calculates 1.02 ms as the delay time cumulative value at the time instant t5. Since the delay time cumulative value exceeds the first threshold, the identification unit 210 does not identify the signal received at the time instant t5 as the reference signal.

Subsequently, the signal determination device 200 further detects a next signal at a time instant t6 when a time of further 8.5 ms has elapsed from the time instant t5. The identification unit 210 calculates a difference between the time instant t6 and timing at which a time of the period of 10 ms has elapsed from the time instant t5 as the delay time. The delay time at the time instant t6 becomes −1.5 ms. Therefore, the identification unit 210 calculates −0.48 ms as the delay time cumulative value at the time instant t6. Since an absolute value of the delay time cumulative value is the first threshold or less, the identification unit 210 sets the signal received at the time instant t6 as the reference signal, and sets the time instant t6 as the reference time instant. At this time, the identification unit 210 resets the delay time cumulative value to 0.

Subsequently, the signal determination device 200 further detects a next signal at a time instant t7 when a time of further 10.4 ms has elapsed from the time instant t6. The identification unit 210 calculates a difference between the time instant t7 and timing at which a time of the period of 10 ms has elapsed from the time instant t6 as the delay time. Since the delay time cumulative value is reset to 0 at the time instant t6, the delay time at the time instant t7 becomes 0.4 ms. Therefore, the identification unit 210 calculates 0.4 ms as the delay time cumulative value at the time instant t7. Since the delay time cumulative value is the first threshold or less, the identification unit 210 identifies the signal received at the time instant t7 as the reference signal, and sets the time instant t7 as a reference time instant.

In this manner, when a new signal is detected, when a shift between timing at which the new signal is detected and reference timing that is timing after a positive integer multiple of a signal period from the reference time instant is the first threshold or less, the identification unit 210 identifies the new signal as the reference signal. The identification unit 210 then sets a time instant at which the new signal is detected as a reference time instant to be used to detect an illegal signal.

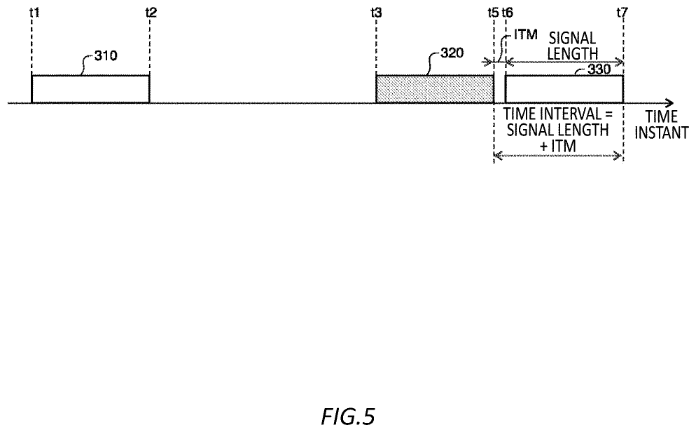

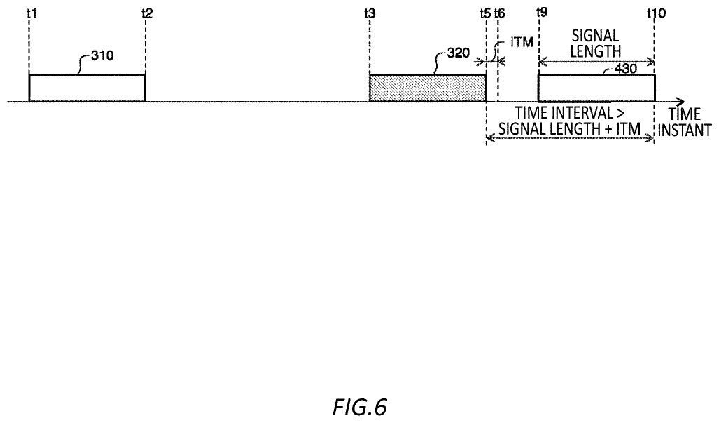

Then, with reference to FIG. 5 and FIG. 6, a situation will be described where a transmission delay occurs because of contention between input of a signal to the communication network 180 and input of another signal.

FIG. 5 schematically illustrates a state in which a signal 330 is delayed from the periodic input timing of 10 ms due to contention with another signal. In FIG. 5, a signal 310, a signal 320, and the signal 330 are signals input in series to the communication network 180.

The signal 310 is a signal the input of which to the communication network 180 is started from the time instant t1 and is ended at the time instant t2. The signal 320 is a signal the input of which to the communication network 180 is started from the time instant t3 and is ended at the time instant t5. The signal 330 is a signal the input of which to the communication network 180 is started from the time instant t6 and is ended at the time instant t7.

In FIG. 5, the signal 310 and the signal 330 are signals belonging to a signal group that is to be input to the communication network 180 in the period of 10 ms. The signal 310 and the signal 330 are signals to which a same CAN ID is assigned. In FIG. 5, the signal 330 represents a delayed state from the periodic input timing to the communication network 180 because of contention with the signal 320. Herein, the signal 320 is set as a signal to which a CAN ID different from the CAN ID assigned to the signal 310 and the signal 330 is assigned. However, a similar processing can also be applied to a case where the CAN ID of the signal 320 is the same as the CAN ID of the signal 310 and the signal 330.

As an example, as a result of start of the input of the signal 330 to the communication network 180 simultaneously with the signal 320, due to communication contention, the input of the signal 330 to the communication network 180 is started after the time instant t5 which is after end of the input of the signal 320 to the communication network 180. In another example, the signal 330 is a signal the input of which is to be started within a time span in which the signal 320 is input to the communication network 180. In the case of this example, the input of the signal 330 to the communication network 180 is started after the time instant t5 by waiting for a bus to be put into an idle state since the input of the signal 320 to the communication network 180 is ended.

When the signal 330 is to be input to the communication network 180, a bus idle state is established after ITM (intermission) for three bits ends after input of a data frame of the signal 320 to the communication network 180 is ended. Therefore, the input of the signal 330, which is in contention with the signal 320, to the communication network 180 may be started from the time instant t6 when a time for the ITM to end from the time instant t5 has elapsed. A time interval equivalent to the ITM is a predetermined minimum time interval that is to be spaced between signals in series.

When a time interval between the signal 320 and the signal 330, that is, a time interval between the time instant t5 and the time instant t7 is identical to a total value of a signal length of the signal 330 and the ITM, the determination unit 240 may determine that the signal 330 is delayed due to contention with the signal 320. Therefore, the determination unit 240 determines that the signal 330 is a normal signal which has been delayed due to the contention. On the other hand, since the signal 330 is the signal delayed due to the contention, the identification unit 210 does not identify the signal 330 as the reference signal.

In this manner, when the time interval of signals detected in series in the communication network 180 is identical to the total value of the signal length and the ITM, the determination unit 240 may determine that the signal 330 is a normal signal delayed due to contention with another signal. When the time interval of the signals detected in series in the communication network 180 is shorter than a threshold decided by setting a predetermined margin to the total value of the signal length and the ITM, the determination unit 240 may determine that the signal 330 is a normal signal delayed due to contention with another signal.

FIG. 6 schematically illustrates a state in which a signal 430 is delayed from periodic input timing without involving contention with another signal. The signal 310 and the signal 430 are set as signals including a same CAN ID. As being different from the situation illustrated in FIG. 5, the signal 430 is a signal delayed from the periodic input timing without contention with the signal 320.

As illustrated in FIG. 6, input of the signal 430 to the communication network 180 is started from a time instant t9 that is subsequent to the time instant t6. Since a time interval between the signal 320 and the signal 430, that is, a time interval between a time instant t10 and the time instant t5 is sufficiently longer than a total value of a signal length of the signal 430 and the ITM, the determination unit 240 may determine that the signal 430 is delayed from the periodic input timing without involving contention with the signal 320. Therefore, the determination unit 240 determines that the signal 430 is an abnormal signal.

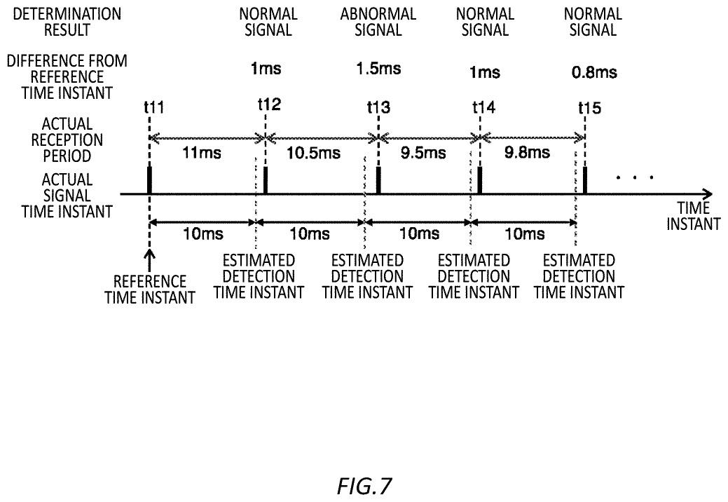

FIG. 7 is a diagram for describing processing for the determination unit 240 to determine whether a signal is a normal signal or an abnormal signal. With reference to FIG. 7, a case will be described where it is determined whether a signal detected after a time instant t11 is set as a reference time instant is a normal signal or an abnormal signal.

In the present embodiment, for clarity of the determination processing of the determination unit 240, a second threshold for determining whether the signal is a normal signal or an abnormal signal is set at 1 ms. That is, when a difference between a time instant at which a signal is detected and an estimated detection time instant which is estimated from the reference time instant and the period T is 1 ms or less, the determination unit 240 determines that the detected signal is a normal signal. The second threshold may be set by taking into account an estimation error of the estimated detection time instant which is calculated based on an estimation error of the period T. In the present embodiment, for a purpose of ease of illustration, the description will be provided where the first threshold (0.5 ms) is ½ of the second threshold (1 ms), but the first threshold may be ⅕ or less of the second threshold. The first threshold may be 1/10 of the second threshold.

With reference to FIG. 7, the signal determination device 200 detects a new signal at a time instant t12 when a time of 11 ms has elapsed from the time instant t11. The timing estimation unit 230 estimates a time instant that is subsequent to the reference time instant by the period of 10 ms as an estimated detection time instant at which a next signal is to be detected after the signal at the time instant t11. A difference between the time instant t12 and the estimated detection time instant is 1 ms. That is, the difference between the time instant t12 and the estimated detection time instant is 1 ms or less. Therefore, the determination unit 240 determines that the signal detected at the time instant t12 is a normal signal.

Subsequently, the signal determination device 200 detects a new signal at a time instant t13 when a time of 10.5 ms has elapsed from the time instant t12. The timing estimation unit 230 estimates a time instant that is subsequent to the reference time instant by 10×2 ms as an estimated detection time instant at which a next signal is to be detected after the signal at the time instant t12. A difference between the time instant t13 and the estimated detection time instant is 1.5 ms. That is, the difference between the time instant t13 and the estimated detection time instant exceeds 1 ms. Therefore, the determination unit 240 determines that the signal detected at the time instant t13 is an abnormal signal.

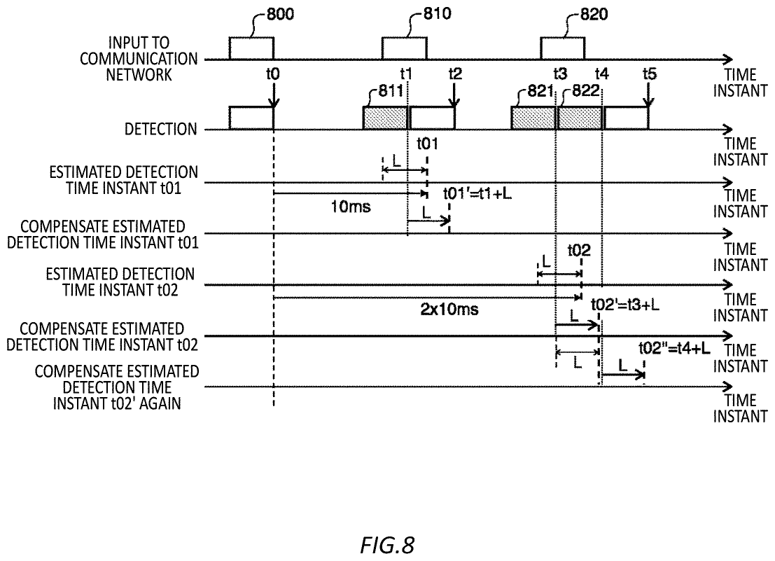

As described in connection to FIG. 4 and the like, when the input of the signal to the communication network 180 is in contention with another signal, the detection time instant of the signal may be delayed from the estimated detection time instant. Accordingly, the determination unit 240 may determine whether the signal detected at the time instant t13 is delayed at the time of the input to the communication network 180 due to contention with another signal. When it may be determined that the signal detected at the time instant t13 is delayed due to contention with another signal at the time of transmission, the determination unit 240 may determine that the signal detected at the time instant t13 is a normal signal. When it is determined that the signal detected at the time instant t13 is not delayed due to contention with another signal at the time of transmission, the determination unit 240 may determine that the signal detected at the time instant t13 is an abnormal signal. This processing will be specifically described in connection to FIG. 8.

Subsequently, the signal determination device 200 detects a new signal at a time instant t14 when a time of 9.5 ms has elapsed from the time instant t13. The timing estimation unit 230 sets a time instant that is subsequent to the reference time instant by 10×3 ms as an estimated detection time instant at which a next signal is to be detected after the signal at the time instant t13. A difference between the time instant t14 and the estimated detection time instant is 1 ms. That is, the difference between the time instant t14 and the estimated detection time instant is 1 ms or less. Therefore, the determination unit 240 determines that the signal detected at the time instant t14 is a normal signal.

Subsequently, the signal determination device 200 detects a new signal at a time instant t15 when a time of 9.8 ms has elapsed from the time instant t14. The timing estimation unit 230 sets a time instant that is subsequent to the reference time instant by 10×4 ms as an estimated detection time instant at which a next signal is to be detected after the signal at the time instant t14. A difference between the time instant t15 and the reference timing is 0.8 ms. That is, the time instant t15 is within a range of ±1 ms with the reference timing set as a center. Therefore, the determination unit 240 determines that the signal detected at the time instant t15 is a normal signal.

In this manner, the timing estimation unit 230 estimates a time instant that is subsequent to a positive integer multiple of the period of 10 ms from the reference time instant as the estimated detection time instant at which a plurality of signals is to be input to the communication network 180 after the reference time instant is to be detected. When a difference between the detection time instant of the new signal and the corresponding estimated detection time instant is a predetermined value or less, the determination unit 240 determines that the new signal is a normal signal. On the other hand, when the difference between the detection time instant of the new signal and the corresponding estimated detection time instant exceeds the predetermined value, the determination unit 240 may determine that the new signal is an abnormal signal.

As described above, the estimated detection time instant is estimated by adding the period to a specific reference time instant. Since an estimation error of the period T is accumulated for the estimated detection time instant, as an elapsed time from the reference time instant is longer, an estimation accuracy of the estimated detection time instant is lower. Therefore, the identification unit 210 desirably updates the reference time instant before an accumulation error caused by the estimation error of the period and a number of times to add the period (positive integer by which the period is multiplied) reaches a predetermined value. For example, the identification unit 210 desirably updates the reference time instant before the number of times to add the period which is used to calculate the estimated detection time instant reaches a predetermined maximum value. Furthermore, the time interval estimation unit 220 desirably sets the time span T0 described in connection to FIG. 3 according to the number of times to add the period which is used to calculate the estimated detection time instant. For example, the time interval estimation unit 220 may set the time span T0 according to the maximum value of the number of times to add the period which is used to calculate the estimated detection time instant. As an example, as the number of times to add the period which is used to calculate the estimated detection time instant is higher, the time interval estimation unit 220 desirably sets a longer period as the time span T0. In addition to the above, each time a predetermined time elapses, the time interval estimation unit 220 desirably updates the period T.

FIG. 8 illustrates determination processing when input of a signal to the communication network 180 causes contention with another signal. In FIG. 8, a signal 800, a signal 810, and a signal 820 are input to the communication network 180 from a specific ECU and are signals set as determination targets on whether the signal is a normal signal in the ECU 110. A signal 811, a signal 821, and a signal 822 are signals input to the communication network 180 from another ECU. The signal 811, the signal 821, and the signal 822 are assigned with a CAN ID different from the CAN ID assigned to the signal 800, the signal 810, and the signal 820.

The signal determination device 200 detects the signal 800 at a time instant t0. Herein, the time instant t0 is set as a reference time instant. The timing estimation unit 230 estimates a time instant t01 that is subsequent to the reference time instant t0 by the period of 10 ms as the estimated detection time instant at which the signal 810 is to be detected in the communication network 180. The timing estimation unit 230 further estimates a time instant t02 that is subsequent to the reference time instant t0 by 2×10 ms as the estimated detection time instant at which the signal 820 is to be detected in the communication network 180.

As illustrated in FIG. 8, the signal 810 is detected at the time instant t2 with the delay from the estimated detection time instant t01 due to the delay based on the contention with the signal 811. The determination unit 240 determines whether a signal assigned with a CAN ID other than the CAN ID set as the determination target is detected within a time span from a time instant that precedes the estimated detection time instant t01 by a predetermined time span to the estimated detection time instant t01. As an example, the determination unit 240 may determine whether a signal assigned with a CAN ID other than the CAN ID set as the determination target is being input to the communication network 180 within a time span from a time instant that precedes the estimated detection time instant to, by a signal length L to the estimated detection time instant t01.

As illustrated in FIG. 8, the signal 811 is input within the time span from the time instant that precedes the estimated detection time instant t01 by the signal length L to the estimated detection time instant t01. In this case, the determination unit 240 determines that the next signal after the signal 800 is delayed due to contention with the signal 811. In this case, the determination unit 240 compensates the estimated detection time instant t01 by setting a time instant that is subsequent to the detection time instant t1 of the signal 811 by the signal length L as a new estimated detection time instant t01′. By comparing the time instant t2 at which the signal 810 is detected with the estimated detection time instant t01′, the determination unit 240 determines whether the signal 810 detected at the time instant t2 is a normal signal. In the example of FIG. 8, since a difference between the time instant t2 at which the signal 810 is detected and the estimated detection time instant t01′ is 1 ms or less, the determination unit 240 determines that the signal 810 detected at the time instant t2 is a normal signal.

Next, processing on the signal 820 will be described. As illustrated in FIG. 8, after being delayed due to contention with the signal 821, the signal 820 is further delayed due to contention with the signal 822, and is detected at the time instant t5 with a delay from the estimated detection time instant t02. The determination unit 240 determines whether a signal assigned with a CAN ID other than the CAN ID set as the determination target is detected within a time span from a time instant that precedes an estimated detection time instant t02 by a predetermined time span to the estimated detection time instant t02. As an example, the determination unit 240 may determine whether a signal assigned with a CAN ID other than the CAN ID set as the determination target is being input to the communication network 180 within a time span from a time instant that precedes the estimated detection time instant t02 by the signal length L to the estimated detection time instant t02.

As illustrated in FIG. 8, the signal 821 is input within the time span from the time instant that precedes the estimated detection time instant t02 by the signal length L to the estimated detection time instant t02. In this case, the determination unit 240 determines that the next signal after the signal 810 is delayed due to contention with the signal 821. In this case, the determination unit 240 compensates the estimated detection time instant t02 by setting a time instant that is subsequent to the detection time instant t3 of the signal 821 by the signal length L as a new estimated detection time instant t02′.

As illustrated in FIG. 8, the signal 822 is input within a time span from a time instant that precedes the compensated estimated detection time instant t02′ by the signal length L to the estimated detection time instant t02. In this case, the determination unit 240 determines that the next signal after the signal 810 is delayed due to contention with the signal 822. In this case, the determination unit 240 further compensates the estimated detection time instant t02′ by setting a time instant that is subsequent to the detection time instant t4 of the signal 822 by the signal length L as a new estimated detection time instant t02″. By comparing the time instant t5 at which the signal 820 is detected with the estimated detection time instant t02″, the determination unit 240 determines whether the signal 820 detected at the time instant t5 is a normal signal. In the example of FIG. 8, since a difference between the time instant t5 at which the signal 820 is detected and the estimated detection time instant t02″ is 1 ms or less, the determination unit 240 determines that the signal 820 detected at the time instant t5 is a normal signal.

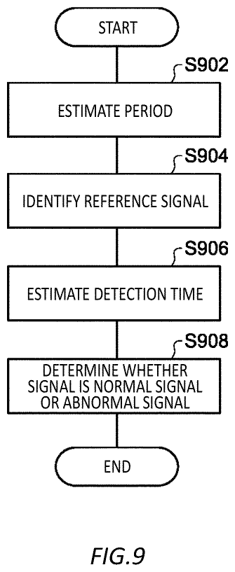

FIG. 9 is a flowchart illustrating overall processing related to the signal determination method executed by the ECU 110. In 5902, the time interval estimation unit 220 estimates a period of a signal set as a determination target on whether the signal is a normal signal. For example, the time interval estimation unit 220 estimates the period of the signal set as the determination target on whether the signal is a normal signal by a method in connection to FIG. 3 and the like.

In 5904, the identification unit 210 identifies a reference signal. For example, the identification unit 210 identifies the reference signal by a method in connection to FIG. 4 and the like.

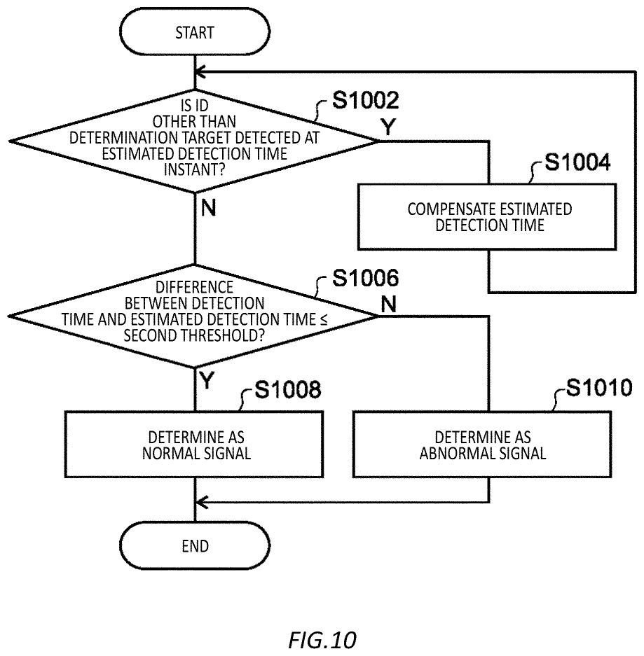

In 5906, the timing estimation unit 230 estimates a time instant at which a plurality of signals is to be detected after the reference signal. For example, as described in connection to the estimated detection time instant in FIG. 7 and the like, the timing estimation unit 230 estimates a time instant that is subsequent to the reference time instant, which is the time instant at which the reference signal is detected, by a positive integer multiple of the period of 10 ms as a time instant at which a plurality of signals is to be detected after the reference signal. In 5908, the determination unit 240 determines whether each signal detected after the reference signal is a normal signal or an abnormal signal. Processing in S908 will be described in connection to FIG. 10.

The processing of the flowchart in FIG. 9 may be executed each time a predetermined time has elapsed to regularly update the period or the reference signal.

FIG. 10 is a flowchart related to determination processing on whether a signal is a normal signal or an abnormal signal. The processing of the flowchart in FIG. 10 can be applied to S908 in FIG. 9. The processing in FIG. 10 is repeatedly executed by the determination unit 240.

In 51002, the determination unit 240 determines whether a signal assigned with a CAN ID other than the CAN ID set as the determination target on whether the signal is a normal signal is detected around the estimated detection time instant. When the signal assigned with the CAN ID other than the CAN ID set as the determination target is detected, in 51004, the timing estimation unit 230 compensates the estimated detection time instant. For example, the timing estimation unit 230 compensates the estimated detection time instant by a method in connection to FIG. 8 and the like.

In 51002, when the signal assigned with the CAN ID other than the CAN ID set as the determination target is not detected, in 51006, it is determined whether a difference between the detection time instant of the signal and the corresponding estimated detection time instant is the second threshold or less. When the difference between the detection time instant of the signal and the corresponding estimated detection time instant is the second threshold or less, in 51008, the determination unit 240 determines that the detected signal is a normal signal. When the difference between the detection time instant of the signal and the corresponding estimated detection time instant exceeds the second threshold, in 51010, the determination unit 240 determines that the detected signal is an abnormal signal.

In the communication network 180, when contention occurs when signals are input to the communication network 180, the signals are transmitted according to a priority order by communication arbitration. Thus, a delay may occur until the signal is actually input to the communication network 180. Therefore, when an abnormal signal is determined by using a detection time instant of the delayed signal as the reference time instant, the determination on whether the signal is a normal signal may be erroneously performed. To deal with this, in accordance with the signal determination device 200, in a case where a new signal is detected in the signal determination device 200, when a difference between a detection time instant of the new signal and a time instant that is subsequent to the reference time instant by a positive integer multiple of the signal period is the first threshold or less, the identification unit 210 sets the new signal as the reference signal, and sets the time instant at which the new signal is detected as the reference time instant. In this manner, the reference time instant for detecting the signal that is to be illegally input to the communication network 180 can be appropriately set.

With regard to each of a plurality of signals detected after the reference time instant, when a difference between a time instant at which each of signals is detected and an estimated detection time instant that is subsequent to the reference time by a positive integer multiple of the signal period is the second threshold or less, the timing estimation unit 230 then determines that the new signal is a normal signal. According to the present embodiment, instead of performing the determination based on a time interval between a detection time instant of the immediately preceding signal and a detection time instant of the latest signal, the determination is performed by comparing the estimated detection time instant estimated based on the appropriately set reference time instant and the actually measured period, and the detection time instant at which the plurality of signals is detected after the reference time instant. Therefore, according to the present embodiment, as compared to a case where the determination is performed based on the time interval between the detection time instant of the immediately preceding signal and the detection time instant of the latest signal, the determination hardly experiences an effect which is generated since the time interval between the detection time instant of the immediately preceding signal and the detection time instant of the latest signal may be changed due to a communication delay and the like. Thus, according to the present embodiment, it becomes possible to appropriately detect whether the signal detected in the communication network 180 is a normal signal or an abnormal signal.

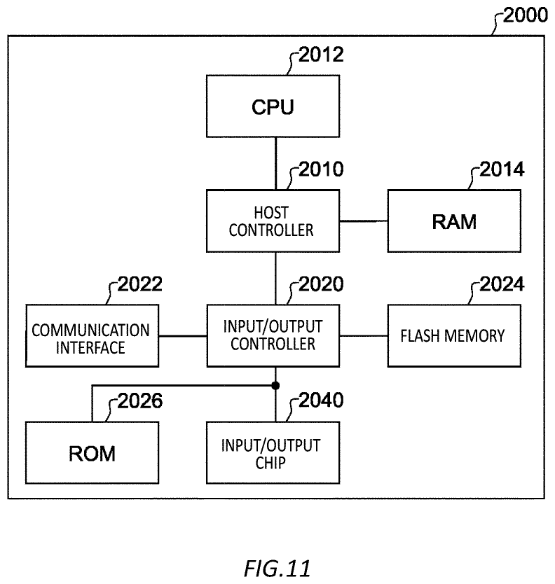

FIG. 11 illustrates an example of a computer 2000 in which a plurality of embodiments of the present invention can be entirely or partially embodied. A program installed in the computer 2000 can allow the computer 2000 to: function as systems such as the system 20 according to embodiments or components of the systems, or as apparatuses such as the ECU 110 or components of the apparatuses; perform operations associated with the systems or components of the systems or with the apparatuses or components of the apparatuses; and/or perform processes according to embodiments or steps in the processes. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with other electronic devices via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer readable storage medium such as a CD-ROM, a DVD-ROM, or a memory card. The RAM 2014, the ROM 2026, or the flash memory 2024 is an example of the computer readable storage medium. The program is installed in the flash memory 2024, the RAM 2014 or the ROM 2026 and executed by the CPU 2012. Information processing written in these programs is read by the computer 2000, and provides cooperation between the programs and the various types of hardware resources described above. A device or a method may be actualized by executing operations or processing of information depending on a use of the computer 2000.

For example, when communication is executed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 to be read into the RAM 2014, and execute various types of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various types of processing including various types of operations, information processing, conditional judgement, conditional branching, unconditional branching, information retrieval/replacement, or the like described in this specification and specified by instruction sequences of the programs, and write back a result into the RAM 2014. In addition, the CPU 2012 may search for information in a file, a database, or the like in the recording medium. For example, when multiple entries, each having an attribute value of a first attribute associated with an attribute value of a second attribute, is stored in the recording medium, the CPU 2012 may search for an entry having a designated attribute value of the first attribute that matches a condition from the multiple entries, and read the attribute value of the second attribute stored in the entry, thereby obtaining the attribute value of the second attribute associated with the first attribute that satisfies a predefined condition.

The programs or software modules explained above may be stored in the computer readable storage medium on the computer 2000 or in the vicinity of the computer 2000. A recording medium such as a hard disk or a RAM provided in a server system connected to a dedicated communication network or the Internet can be used as the computer readable storage medium. A program stored in the computer readable storage medium may be provided to the computer 2000 via a network.

A program, which is installed on the computer 2000 and causes the computer 2000 to function as the ECU 110, may work on the CPU 2012 or the like to cause the computer 2000 to function as each unit of the ECU 110. The information processing written in these programs are read by the computer 2000 to cause the computer to function as each unit of the ECU 110, which is specific means realized by the cooperation of software and the various types of hardware resources described above. Then, by the specific means realizing calculation or processing of information according to a purpose of use of the computer 2000 in the present embodiment, the unique ECU 110 according to the purpose of use is constructed.

Various embodiments have been explained with reference to the block diagrams and the like. In the block diagrams, each block may represent (1) a stage of a process in which an operation is executed, or (2) each unit of the device having a role in executing the operation. A specific stage and unit may be implemented by a dedicated circuit, a programmable circuit supplied with computer readable instructions stored on a computer readable storage medium, and/or a processor supplied with computer readable instructions stored on a computer readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and other logical operations, and a memory element such as a flip-flop, a register, a field programmable gate array (FPGA), a programmable logic array (PLA), or the like.

The computer readable storage medium may include any tangible device capable of storing instructions to be executed by an appropriate device. Thereby, the computer readable storage medium having instructions stored therein forms at least a part of a product including instructions which can be executed to provide means for executing processing procedures or operations specified in the block diagrams. Examples of the computer readable storage medium may include an electronic storage medium, a magnetic storage medium, an optical storage medium, an electromagnetic storage medium, a semiconductor storage medium, and the like. More specific examples of the computer readable storage medium may include a floppy disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disc (DVD), a Blu-ray (registered trademark) disc, a memory stick, an integrated circuit card, or the like.

The computer readable instruction may include an assembler instruction, an instruction-set-architecture (ISA) instruction, a machine instruction, a machine dependent instruction, a microcode, a firmware instruction, state-setting data, or either of source code or object code written in any combination of one or more programming languages including an object-oriented programming language such as Smalltalk (registered trademark), JAVA (registered trademark), and C++, and a conventional procedural programming language such as a “C” programming language or a similar programming language.

Computer readable instructions may be provided to a processor of a general purpose computer, a special purpose computer, or other programmable data processing device, or to programmable circuit, locally or via a local area network (LAN), wide area network (WAN) such as the Internet, and a computer readable instruction may be executed to provide means for executing operations specified in the explained processing procedures or block diagrams. An example of the processor includes a computer processor, a processing unit, a microprocessor, a digital signal processor, a controller, a microcontroller, or the like.

While the present invention has been described with the embodiments, the technical scope of the present invention is not limited to the above described embodiments. It is apparent to persons skilled in the art that various alterations and improvements can be added to the above described embodiments. It is also apparent from the description of the claims that the embodiments to which such alterations or improvements are made can be included in the technical scope of the present invention.

The operations, procedures, steps, and stages etc. of each process performed by a device, system, program, and method shown in the claims, specification, or diagrams can be executed in any order as long as the order is not indicated by “before”, “prior to”, or the like and as long as the output from a previous process is not used in a later process. Even if the process flow is described using phrases such as “first” or “next” in the claims, specification, or drawings, it does not necessarily mean that the process must be performed in this order.

### EXPLANATION OF REFERENCES

10: movable object;
20: system;
100: ECU;
110: ECU;
111: ECU;
120: ECU;
121: ECU;
180: communication network;
200: signal determination device;
210: identification unit;
220: time interval estimation unit;
230: timing estimation unit;
240: determination unit;
280: storage unit;
310, 320, 330, 430, 800, 810, 811, 820, 821, 822: signal;
2000: computer;
2010: host controller;
2012: CPU;
2014: RAM;
2020: input/output controller;
2022: communication interface;
2024: flash memory;
2026: ROM;
2040: input/output chip.

What is claimed is:

1. A signal determination device which determines whether a signal that is input to communication network is a normal signal, the signal determination device comprising:
an identification unit which identifies a reference signal that serves as a reference to identify an abnormal signal among a plurality of signals detected in the communication network;
a time interval estimation unit which estimates a time interval of signals that are to be input in series to the communication network based on detection timing of the plurality of signals detected in the communication network;
a timing estimation unit which estimates timing at which a plurality of signals is to be detected in the communication network after the reference signal based on detection timing of the reference signal and the time interval; and
a determination unit which determines whether each of the plurality of signals detected in the communication network after the reference signal is a normal signal based on the timing estimated by the timing estimation unit and detection timing of the plurality of signals detected in the communication network after the reference signal.

2. The signal determination device according to claim 1, wherein the timing estimation unit calculates timing which is calculated by adding a value obtained by multiplying the time interval by a positive integer to the detection timing of the reference signal, as the timing at which the plurality of signals is to be detected in the communication network after the reference signal.

3. The signal determination device according to claim 1, wherein when a difference between detection timing of a signal detected in the communication network after the reference signal and the timing estimated by the timing estimation unit is a predetermined value or less, the determination unit determines that the signal detected in the communication network after the reference signal is a normal signal.

4. The signal determination device according to claim 1, wherein the time interval estimation unit estimates the time interval based on a mean value of differences of detection timing of signals detected in series in the communication network within a predetermined time span.

5. The signal determination device according to claim 4, wherein
the timing estimation unit calculates timing which is calculated by adding a value obtained by multiplying the time interval by a positive integer to the detection timing of the reference signal, as the timing at which the plurality of signals is to be detected in the communication network after the reference signal, and
the time interval estimation unit sets a length of the predetermined period according to the positive integer by which the time interval is multiplied.

6. The signal determination device according to claim 5, wherein the time interval estimation unit sets a length of the predetermined time span such that an error of the timing estimated by the timing estimation unit which is predicted from the positive integer becomes a predetermined value or less.

7. The signal determination device according to claim 1, wherein the time interval estimation unit updates the time interval before a predetermined time elapses.

8. The signal determination device according to claim 1, wherein the identification unit updates the reference signal by identifying, as a new reference signal, a signal detected after a currently set reference signal before a predetermined time elapses.

9. The signal determination device according to claim 1, wherein at estimated timing at which a first signal is to be detected, when a second signal that is not a signal of a determination target on whether a signal is a normal signal is detected, the timing estimation unit newly estimates timing obtained by adding a predetermined signal length to detection timing of the second signal as the timing at which the first signal is to be detected.

10. The signal determination device according to claim 1, wherein when a difference between detection timing of a first signal detected in the communication network after the reference signal that is currently set and timing at which a positive integer multiple of the time interval has elapsed from detection timing of the reference signal is a predetermined value or less, the identification unit identifies the first signal as a new reference signal.

11. The signal determination device according to claim 1, wherein
when a time interval between a first signal and a second signal which are detected in series in the communication network is a predetermined interval or less, the identification unit does not identify the second signal as the reference signal, and
based on a requirement that at least the time interval between the first signal and second signal detected in series in the communication network exceeds the predetermined interval, the identification unit identifies the second signal as the reference signal.

12. The signal determination device according to claim 1, wherein the communication network is a communication network compliant to a control area network (CAN) standard.

13. The signal determination device according to claim 2, wherein when a difference between detection timing of a signal detected in the communication network after the reference signal and the timing estimated by the timing estimation unit is a predetermined value or less, the determination unit determines that the signal detected in the communication network after the reference signal is a normal signal.

14. The signal determination device according to claim 2, wherein the time interval estimation unit estimates the time interval based on a mean value of differences of detection timing of signals detected in series in the communication network within a predetermined time span.

15. The signal determination device according to claim 14, wherein
the timing estimation unit calculates timing which is calculated by adding a value obtained by multiplying the time interval by a positive integer to the detection timing of the reference signal, as the timing at which the plurality of signals is to be detected in the communication network after the reference signal, and
the time interval estimation unit sets a length of the predetermined period according to the positive integer by which the time interval is multiplied.

16. The signal determination device according to claim 15, wherein the time interval estimation unit sets a length of the predetermined time span such that an error of the timing estimated by the timing estimation unit which is predicted from the positive integer becomes a predetermined value or less.

17. A movable object comprising the signal determination device according to claim 1.

18. The movable object according to claim 17, wherein the movable object is a vehicle.

19. A signal determination method of determining whether a signal that is input to communication network is a normal signal, the signal determination method comprising:
identifying a reference signal that serves as a reference to identify an abnormal signal among a plurality of signals detected in the communication network;
estimating a time interval of signals that are to be input in series to the communication network based on detection timing of the plurality of signals detected in the communication network;
estimating timing at which a plurality of signals is to be detected in the communication network after the reference signal based on detection timing of the reference signal and the time interval; and
determining whether each of the plurality of signals detected in the communication network after the reference signal is a normal signal based on the timing estimated in the estimating the timing and detection timing of the plurality of signals detected in the communication network after the reference signal.

20. A non-transitory computer readable storage medium storing a program for causing a computer to function as a signal determination device which determines whether a signal that is input to communication network is a normal signal, the program causing the computer to function as:
an identification unit which identifies a reference signal that serves as a reference to identify an abnormal signal among a plurality of signals detected in the communication network;
a time interval estimation unit which estimates a time interval of signals that are to be input in series to the communication network based on detection timing of the plurality of signals detected in the communication network;
a timing estimation unit which estimates timing at which a plurality of signals is to be detected in the communication network after the reference signal based on detection timing of the reference signal and the time interval; and
a determination unit which determines whether each of the plurality of signals detected in the communication network after the reference signal is a normal signal based on the timing estimated by the timing estimation unit and detection timing of the plurality of signals detected in the communication network after the reference signal.
